(19) United States
(12) Patent Application Publication
(10) Pub. No.: US 2024/0409097 A1
(43) Pub. Date: Dec. 12, 2024

(54) DRIVING ASSIST APPARATUS AND DRIVING ASSIST PROGRAM

(71) Applicants: DENSO CORPORATION, Kariya-city (JP); TOYOTA JIDOSHA KABUSHIKI KAISHA, Toyota-shi (JP)

(72) Inventors: Naotsugu SHIMIZU, Tokyo (JP); Koji TAKEUCHI, Toyota-shi (JP); Junya FUKUTA, Toyota-shi (JP)

(21) Appl. No.: 18/810,296

(22) Filed: Aug. 20, 2024

Related U.S. Application Data
(63) Continuation of application No. PCT/JP2023/002249, filed on Jan. 25, 2023.

(30) Foreign Application Priority Data
Feb. 22, 2022 (JP) 2022-025924

(51) Int. Cl. B60W 30/18

(52) U.S. Cl. CPC B60W 30/18163; B60W 2420/403; B60W 2552/53; B60W 2554/4041

(57) ABSTRACT

A driving assist apparatus that performs, in accordance with periphery monitoring information of an own vehicle acquired from a periphery monitoring apparatus, a driving assist operation of the own vehicle. The driving assist apparatus is provided with a travelling locus calculation unit that calculates a travelling locus of the own vehicle; an operation region calculation unit that calculates an operation region in the vicinity of the own vehicle; a lane change detection unit that detects a lane change of the own vehicle; an operation region correction unit that corrects the operation region based on lane information related to a traffic lane after the lane change of the own vehicle; and an operation determination unit that determines, when an object is detected in the operation region, whether the driving assist operation needs to be activated based on the periphery monitoring information.

### CROSS-REFERENCE OF RELATED APPLICATIONS

This application is the U.S. bypass application of International Application No. PCT/JP2023/002249 filed on Jan. 25, 2023, which designated the U.S. and claims priority to Japanese Patent Application No. 2022-025924 filed on Feb. 22, 2022, the contents of both of these are incorporated herein by reference.

### BACKGROUND

### Technical Field

The present disclosure relates to a driving assist apparatus and a driving assist program.

### Description of the Related Art

As a conventional technique, a driving assist apparatus is disclosed in which an operation region is set on an adjacent lane adjacent to a traffic lane where the own vehicle travels, and the operation region is monitored for whether other vehicles are present in the operation region, thereby performing a driving assist operation. According to this driving assist apparatus, a travelling locus of an own vehicle is calculated based on the odometry information and the operation region is estimated based on the calculated travelling locus of the own vehicle.

### SUMMARY

The present disclosure provides a driving assist apparatus that performs, in accordance with periphery monitoring information of an own vehicle acquired from a periphery monitoring apparatus, a driving assist operation of the own vehicle.

The driving assist apparatus includes: a travelling locus calculation unit that calculates a travelling locus of the own vehicle; an operation region calculation unit that calculates an operation region in the vicinity of the own vehicle, based on the travelling locus of the own vehicle calculated by the travelling locus calculation unit; a lane change detection unit that detects a lane change of the own vehicle; an operation region correction unit that corrects, when the lane change detection unit detects the lane change of the own vehicle, the operation region based on lane information related to a traffic lane after the lane change of the own vehicle; and an operation determination unit that determines, when an object is detected in the operation region, whether the driving assist operation needs to be activated based on the periphery monitoring information.

### BRIEF DESCRIPTION OF THE DRAWINGS

The foregoing object and other objects, features, and advantages of the present disclosure will be more clarified by the following detailed descriptions with reference to the accompanying drawings. The drawings are as follows:

FIG. 1 is a block diagram showing a driving assist system including a driving assist apparatus according to a first embodiment;

FIG. 2 is a diagram showing object detection regions in the vicinity of the own vehicle;

FIG. 3 is a diagram showing a travelling locus of the own vehicle and an operation region calculated based on the travelling locus of the own vehicle;

FIG. 4 is a diagram showing a corrected operation region corrected due to a detection of a lane change;

FIG. 5 is a flowchart showing a driving assist process performed by the driving assist apparatus according to the first embodiment;

FIG. 6 is a diagram showing a change in a distance between the own vehicle and a white marking when changing the traffic lane;

FIG. 7 is a flowchart showing a driving assist process performed by the driving assist apparatus according to the first embodiment; and FIG. 8 is an explanatory diagram showing a detection of a traffic lane in accordance with

### DETAILED DESCRIPTION OF THE PREFERRED EMBODIMENTS

As a conventional technique, for example, patent literature JP-A-2016-85567 disclosures a driving assist apparatus in which an operation region is set on an adjacent lane adjacent to a traffic lane where the own vehicle travels, and the operation region is monitored for whether other vehicles are present in the operation region, thereby performing a driving assist operation. According to the driving assist apparatus, a travelling locus of an own vehicle is calculated based on the odometry information and the operation region is estimated based on the calculated travelling locus of the own vehicle.

In the case where the own vehicle travels without taking account of the shape of the traffic lane, when changing the lane for example, the operation region calculated based on the travelling locus of the own vehicle may be different from the shape of the traffic lane. In this case, the operation region is set on a region having a low risk to the own vehicle, whereby an unnecessary alert is outputted when another vehicle enters the operation region even though it is a low risk to the own vehicle.

### First Embodiment

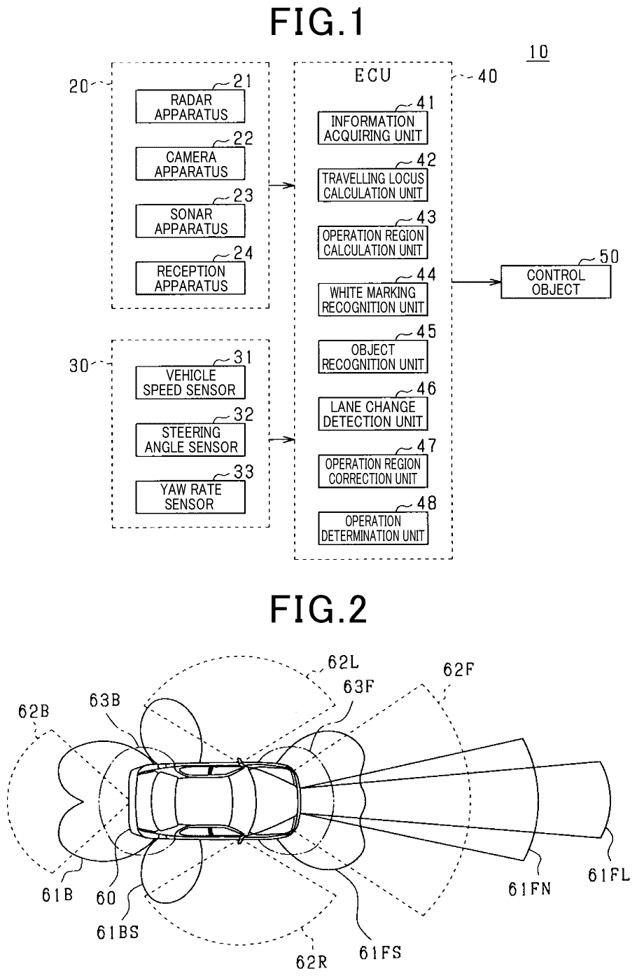

As shown in FIG. 1, a driving assist system 10 according to embodiments is provided with a periphery monitoring apparatus 20, odometry sensors 30, an ECU 40 and a control object 50. The driving assist system 10 is mounted on a vehicle, and the ECU 40 functions as a driving assist apparatus that performs a driving assist function of a vehicle in accordance with periphery monitoring information as the information in the vicinity of the vehicle acquired from the vicinity monitoring apparatus 20.

The vicinity monitoring apparatus 20 is configured of various apparatuses that acquire periphery monitoring information as the information in the vicinity of the own vehicle. The vicinity monitoring apparatus 20 is provided with a radar apparatus 21, a camera apparatus 22, a sonar apparatus 23 and a reception apparatus 24.

The radar apparatus 21 is a known millimeter-wave radar apparatus where a high-frequency signal in a millimeter-wave band is transmitted as transmission waves. For the radar apparatus 21, one apparatus may be installed in the own vehicle or a plurality of apparatuses may be installed in the own vehicle. The radar apparatus 21 is disposed in a frontend part or a rear end part of the own vehicle for example, and detects a location of an object present in a detection range capable of detecting an object, the detection range being a region within a predetermined detection angle. Specifically, the radar apparatus 21 transmits probe waves at predetermined periods and receives reflection waves using a plurality of antennas. The distance to the object can be calculated using a transmission time of the probe waves and a reception time of the reflection waves. Moreover, a relative speed is calculated using a change in the frequency of the reflection waves reflected at the object due to the Doppler effect. Additionally, an azimuth of an object can be calculated using a phase-difference between reflection waves received by the plurality of antennas. When a location and an azimuth of the object are calculated, a relative location of the object with respect to the own vehicle can be identified.

The camera apparatus 22 may be configured as a CCD camera, a CMOS image sensor, or a monocular camera such as near-infrared camera, or a stereo camera. The imaging apparatus 22 may be provided in the own vehicle as a single apparatus or a plurality of apparatuses. The camera apparatus 22 is attached to the vehicle at a predetermined height position in a center portion of the vehicle with respect to the vehicle-width direction, and captures, as a birds-eye view, an image in a region spreading in a predetermined angular range towards a front side or a rear side or a lateral side of the vehicle. The camera apparatus 22 extracts feature points indicating presence of an object in the captured image. Specifically, the camera apparatus 22 extracts edge points based on luminance information of the captured image and performs a Hough transform for the extracted edge points. In the Hough transform, points on a straight line where a plurality of edge points are continuously present or points where straight lines cross each other are extracted as feature points. The camera apparatus 22 subsequently outputs images to be subsequently captured, to the ECU 30 as sensing information.

The sonar apparatus 23 serves as a radar apparatus using ultrasonic waves as probing waves and is mounted on a front end, a rear end and both lateral side surfaces of the own vehicle.

The sonar apparatus 23 is appropriately utilized for measuring a distance to an object in the vicinity of the own vehicle. Specifically, the sonar apparatus 23 transmits probing waves at predetermined periods and receives reflection waves at a plurality of antennas. With a transmission time of the probe waves and a reception time of the reflection waves, a plurality of detection points on the object are detected and a distance to the object is measured. In addition, an azimuth of the object is calculated using a phase difference between reflection waves received by the plurality of antennas. Calculating the distance to the object and the azimuth of the object, a relative position of the object relative to the own vehicle can be identified. Also, according to the sonar apparatus 23, a relative speed of the object can be calculated based on the frequency-change due to the Doppler effect of reflection waves.

The reception apparatus 24 is a GPS reception apparatus and an example of a GNSS (i.e. global navigation satellite system) reception apparatus. With the reception apparatus 24, positioning signals can be received from a global positioning system that determines the current location on the earth using satellites.

The radar apparatus 21, the camera apparatus 22, the sonar apparatus 23 and the reception apparatus 24 are examples of the periphery monitoring apparatus 20 that acquires periphery information of the own vehicle. The periphery monitoring apparatus 20 may further include various detection apparatuses and communication apparatuses capable of acquiring information in the vicinity of the own vehicle. As the periphery monitoring apparatus, for example, a sensor that transmits probing waves of LIDAR (light detection and ranging/laser imaging detection and ranging) apparatus may be provided. Also, a communication apparatus related to V2X (vehicle-to-everything) communication including intervehicle communication referred to as V2V may be provided. The periphery monitoring apparatus 20 successively outputs detected or received objects in the vicinity of the own vehicle or information related to the road where the own vehicle travels to the ECU 40 as the periphery monitoring information.

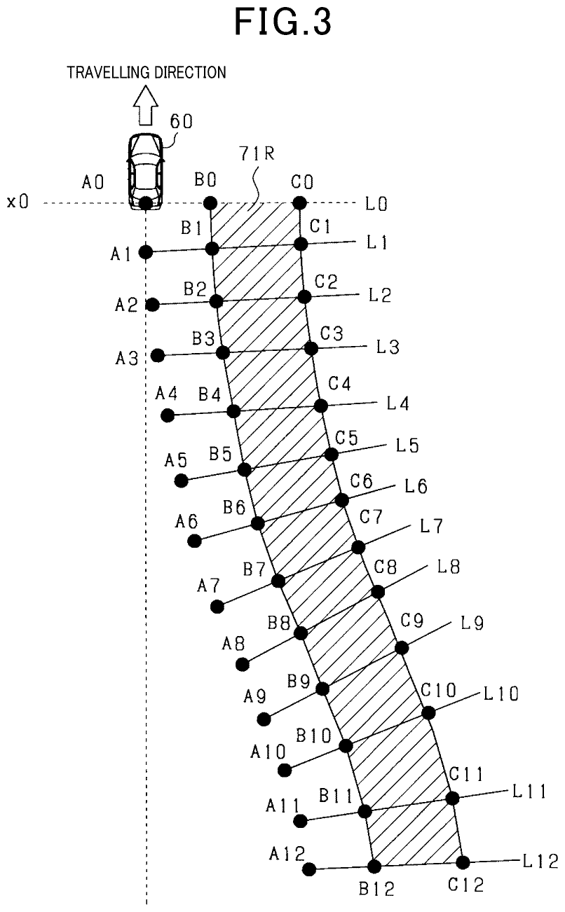

The above-descried periphery monitoring apparatus may detect not only objects in the rear side or laterally rear side of the own vehicle 60, but also objects in the front side or laterally front side of the own vehicle and utilize the detected object as positional information. Also, object to be monitored may be changed depending on type of the periphery monitoring apparatus used. For example, stationary objects such as road signs and buildings, or moving objects such as pedestrians are preferably detected when the camera apparatus 22 is used. Further, when the radar apparatus 21 or the sonar apparatus 23 are used, objects having a larger reflection power are preferable. Moreover, the periphery monitoring apparatus to be used may be selected depending on the type of object or position of object or a moving speed. FIG. 2 exemplifies a region capable of being monitored by various periphery monitoring apparatuses mounted on the own vehicle 60. The regions 61FN, 61FL, 61FS, 61BS and 61B indicated by the solid lines illustrate regions capable of being appropriately monitored by the radar apparatus 21 or the LIDAR apparatus. The regions 62F, 62L, 62R and 62B indicated by the dotted lines illustrate regions capable of being appropriately monitored by the camera apparatus 22. Also, the regions 63F and 63B indicated by the dashed lines illustrate regions capable of being appropriately monitored by the sonar apparatus 23.

The region 61FN may be suitably utilized for a parking assist operation, for example. The region 61FL may be suitably utilized for an adaptive cruise control (ACC) operation. The region 61FS may be suitably utilized for an emergency brake operation, a pedestrian detection operation, a collision avoidance operation, for example. The region 61BS and region 61B are suitably utilized for a rear-end collision alert, a blind-spot monitoring operation. The region 62F may be suitably utilized for a road-sign recognition and a lane departure warning. The region 62L and the region 62R are suitably utilized for a periphery monitoring operation (e.g. surround view). The region 62B may be suitably utilized for a parking assist operation and a periphery monitoring operation.

The odometry sensors 30 are configured of sensors capable of acquiring odometry information indicating an operation state of the own vehicle. The odometry sensors 30 are provided with a vehicle speed sensor 31, a steering sensor 32 and a yaw rate sensor 33. The odometry information include, for example, a vehicle speed 60, a yaw rate, a steering angle, a turning radius and the like.

The vehicle speed sensor 31 detects a travelling speed of the own vehicle 60. For the vehicle speed sensor, a wheel speed sensor capable of detecting rotation speed of the wheels can be used for example. A wheel speed sensor used for the vehicle speed sensor 31 is mounted to, for example, a wheel part of the wheels and outputs a wheel speed signal depending on the wheel speed of the vehicle to the ECU 40.

The steering angle sensor 32 is attached to a steering rod of the vehicle, and outputs a steering angle signal depending on a change in the steering angle of a steering wheel in accordance with a driver's operation to the ECU 40.

The yaw rate sensor 33 may be provided as only one sensor, or a plurality of sensors. When one yaw rate sensor is provided, the sensor is disposed at a center position of the own vehicle 60. The yaw rate sensor 33 outputs a yaw rate signal depending on a change rate of an amount of steering of the own vehicle 60.

The control object 50 is operated based on a control command transmitted from the ECU 40 and is operated by an operation input from the driver. Note that the operation input of the driver may be appropriately processed by the ECU 40 and then inputted to the control object 50 as a control command. The control object 50 is provided with a driving apparatus, a control apparatus, a steering apparatus, an alert apparatus and a display apparatus.

The driving apparatus is configured to drive the vehicle and is controlled by an accelerator operation of the drive or a command from the ECU 40. Specifically, the driving apparatus is, for example, a driving source of a vehicle such as an internal combustion engine, a motor, a storage battery, and respective configurations related to the driving source. The ECU 40 has a function of automatically controlling the driving apparatus depending on a travelling plan or a vehicle state of the own vehicle 60.

The brake apparatus is an apparatus for braking the own vehicle 60, and includes sensors, a motor, and apparatuses (actuators) related to a braking operation such as a valve and a pump. The brake apparatus is controlled by a braking operation of the driver or a command transmitted from the ECU 40. The ECU 40 determines a brake timing and an amount of braking force and controls the brake apparatus such that the determined amount of braking force is acquired at the determined timing.

The steering apparatus is for steering the own vehicle 60 and controlled by a steering operation of the driver or a command transmitted from the ECU 40. The ECU 40 has a function of automatically controlling the steering apparatus in order to perform collision avoidance or lane change.

The alert apparatus is an apparatus for outputting an alert to the driver or the like. Examples of the alert apparatus are an apparatus for acoustically outputting an alert such as a speaker and a buzzer, and an apparatus for visually outputting an alert such as a display device. However, the alert apparatus is not limited to these examples. The alert apparatus an alert sound in response to a control command transmitted from the ECU 40, thereby notifying a driver that there is a risk of collision with an object.

The display device is for visually notifying the driver of a notification and configured as a display device and instruments installed in the vehicle cabin of the own vehicle 60. The display device displays an alert message or the like based on the control command from the ECU 40, thereby notifying the driver that a risk of collision with an object is present.

The control object 50 may include an apparatus controlled by an ECU 40 other than the above-described ECU 40. For example, a safety apparatus that secure safety of the driver. The safety apparatus is exemplified by a door-lock device that controls locking or unlocking of the doors of the vehicle, or a seat-belt device provided with a pretensioner mechanism that draws in the seat-belt disposed at respective seats of the own vehicle 60.

The ECU 40 is provided with an information acquiring unit 41, a traveling locus calculation unit 42, an operation region calculation unit 43, a white marking recognition unit 44, an object recognition unit 45, a lane change detection unit 46, an operation region correction unit 47 and an operation determination unit 48. The ECU 40 causes a CPU including ROM, RAM, I/O and the like to execute programs stored in the ROM, thereby accomplishing these functions. Thus, the ECU 40 generates, based on the information acquired from the periphery monitoring apparatus 20 and the odometry sensors 30, a control command for the control object 50, and outputs the generated control command, whereby the ECU 40 serves as a driving assist apparatus that performs a driving assist of the own vehicle 40.

The information acquiring unit 41 acquires periphery monitoring information from the periphery monitoring apparatus 20 and the odometry information. The ECU 40 may be provided with a memory unit for storing various data acquired by the information acquiring unit 41, and calculation value calculated based on the various data. The ECU 40 may further be configured to store history of the location and the turning angle of the own vehicle 60 on the travelling locus. The location and the turning angle on the travelling locus may be associated when being stored. The location and the turning angle of the own vehicle 60 can be calculated from detection values of the vehicle speed sensor 31, the steering angle sensor 32, the yaw rate sensor 33 and the like.

The travelling locus calculation unit 42 calculate a travelling locus of the own vehicle 60 based on the odometry information acquired from the odometry sensors 30. Note that the travelling locus calculation unit 42 may calculate the travelling locus of the own vehicle using information other than odometry information. For example, other information such as map information acquired by the reception apparatus 24 may be used. Specifically, the travelling locus of the own vehicle is calculated from a time which is a predetermined number of periods (e.g. n cycles, where n is 2 or more natural number) before the present time, each corresponding to a control period T. For example, an own-vehicle-estimated-location, which is an estimated value of the locations of the own vehicle from a time before n-cycles to a time before one-cycle with respect to the current location, is calculated using the acquired odometry information (values acquired at respective control timings from a time before n-cycles). Then, a line connected between the current location and the own-vehicle-estimated-locations, calculated for respective cycles, is calculated to be the travelling locus of the own vehicle.

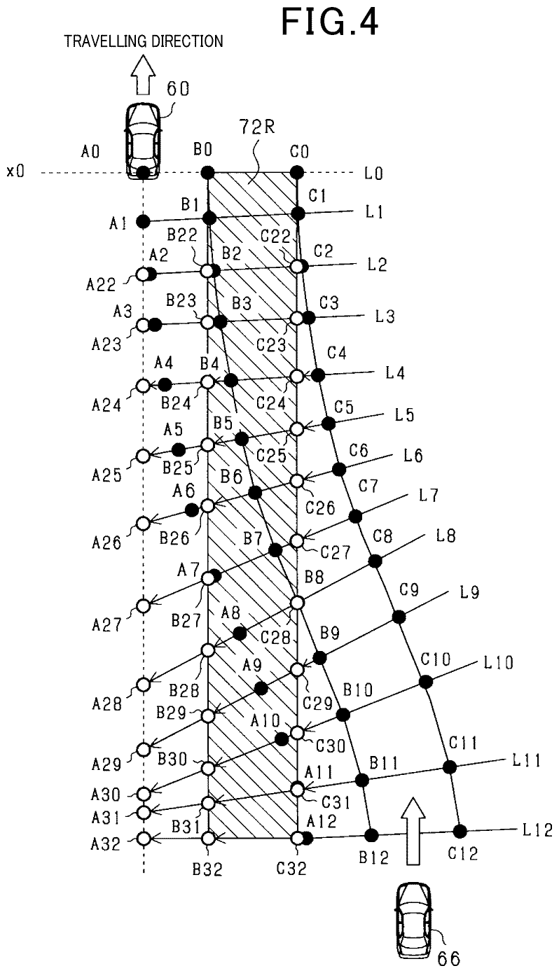

FIG. 3 exemplifies a traveling locus of the own vehicle in the case where n is set as n=12. Note that points A0 to A12 refers to points on the travelling locus of the own vehicle 60. More specifically, each point is a middle point of a line segment connecting left and right wheels of the own vehicle 60 from the past time to the present time. The current location of the own vehicle 60 is indicated by a point A0 and the past locations of the own vehicle 60 are indicated by points A1, A2, . . . A12 back to the past in this order. The points A0 to A12 may be actually measured locations of the own vehicle 60, and some of the locations may be interpolated locations based on the actually measured data. In the case where the points A0 to A12 are acquired at predetermined time intervals, the distance between respective points can be calculated by product between the average speed of the own vehicle and the time interval in the section.

The odometry information such as a travelling speed or a yaw rate of the own vehicle 60 includes errors due to various causes such as a detection error of the vehicle speed sensor or the yaw rate sensor, and noise. Hence, for respective own-vehicle-estimated locations at past control timings back to the past cycles (n-cycles before), an estimated presence range of the own-vehicle-estimated locations may also be calculated taking errors in the odometry information into consideration. The estimated present range can be indicated by an error distribution with reference to the own-vehicle-estimated location. Further, the error distribution is projected in a vehicle width direction (i.e. a direction perpendicular to a travelling direction), whereby a presence probability of the own-vehicle-estimated-location in the vehicle width direction can be expressed by a predetermined probability distribution of which the center is the own-vehicle-estimated-location. For example, the error distribution of the own-vehicle-estimated locations due to an error factor of the odometry information may be modeled as a normal distribution (i.e. Gaussian distribution). In this case, the presence probability of the own-vehicle-estimated-location calculated using the odometry information shows the peak value indicating the highest probability in the normal distribution such that the greater the distance away from the own-vehicle-estimated location in the vehicle width direction, the lower the presence probability in accordance with the normal distribution.

The operation region calculation unit 43 sets the operation region at least in either the rear part or the laterally rear side of the own vehicle 60. The operation region is set as a region for performing the driving assist operation such as controlling a brake, a steering and an alert notification, based on a predetermined condition in the case where an object entering the region is detected. The operation region may be set having any shape and size in the detection region of the radar apparatus 21. For example, when setting the operation region in a laterally right rear side of the own vehicle 60, similar to the operation region 71R shown in FIG. 3, the operation region may preferably be set in a laterally right rear side to be in a belt shape having a lateral width similar to the lane width.

In FIG. 3, points B0 to B12 and points C0 to C12 are positioned on corresponding horizontal lines L0 to L12 which extend in a turning radius direction of the own vehicle 60 from points A0 to A12. Assuming that i=0 to 12, intervals between point Ai and point Bi on the horizontal line Li are the same Y1, and intervals between point Bi and point Ci are the same Y2.

The operation region calculation unit 43 sets the horizontal line Li extending in the normal direction through point Ai in accordance with a turning angle θi corresponding to point Ai on the travelling locus of the own vehicle 60. Then, the operation region calculation unit 43 sets, when the lane width of the own lane where the own vehicle 60 travels is SH, an interval to be the interval Y1=SH/2, Y2=SH, and estimates the position of point Bi as a left side edge of right-side adjacent lane of the own vehicle 60 and the position of point Ci as the right side edge thereof. Then, the operation region calculation unit 43 estimates a region surrounded by the points B0 to B12 and the points C0 to C12 to be an operation region 71R. The operation region 71R is set as a region of the lane width SH which changes calculating a locus similar to the travelling locus in a right side of the travelling locus of the own vehicle 60. As shown in FIG. 3, the operation region 71R is set such that regions each having substantially annular fan shape of which the center is the turning center of the own vehicle 60 are coupled along the travelling locus of the own vehicle 60. As a result, the operation region 71R becomes smaller towards an inner side when the own vehicle 60 is turning.

Further, a left rear side operation region set in the left rear side of the own vehicle 60 can be set or modified, similar to the operation region 71R as the right rear side operation region. The operation region calculation unit 43 linearly extends the horizontal lines L0 to L12 to a left side of the traveling locus of the own vehicle 60 and sets points D0 to D12 and points E0 to E12 on the horizontal line L0 to L12. Thereafter, a region surrounded by the points D0 to D12 and points E0 to E12 is determined as an operation region. Thus, an operation region can be set on the left side of the travelling locus of the own vehicle, corresponding to the lane width SH which changes calculating a locus similar to the travelling locus of the own vehicle 60. Note that intervals between point Ai and point Di on the horizontal line Li are the same SH/2, and intervals between point Di and point Ei are the same SH.

The horizontal width (width in a horizontal line direction) of the operation region may be set based on the lane width SH of the own vehicle as described above or may be set based on actual lane width of the adjacent lane. The lane width may be actually measured by detecting a white marking using the camera apparatus 22, or the lane width may be acquired by the reception apparatus 26. Also, in the above-described embodiments, the lane width SH is determined as each width of the respective operation regions (widths along the horizontal lines). However, it is not limited thereto.

The operation region calculation unit 43 may set the operation region based on information of the own lane where the own vehicle 60 travels or information of adjacent lanes thereof. For example, the operation region may be set based on object information around the own vehicle 60 acquired by the camera apparatus 22 (e.g. surrounded vehicles and pedestrians, road markings such as lane markings and road signs), positional information, map information and traffic information and the like acquired by the reception apparatus 26.

The white marking recognition unit 44 recognizes lane markings of the road where the own vehicle 60 travels. The lane marking includes various lane markings such as a yellow marking or double white markings and the like. According to the present specification, the lane marking may be simply referred to as a white marking. Specifically, the white marking recognition unit 44 extracts edge points as pixels having large changes in their luminance from an image captured by the camera apparatus 22. The edge points are repeatedly extracted while moving the position vertically, that is, in the depth direction of the image, whereby the edge points are extracted from substantially entire region of the image. The extracted edge points are connected, thereby extracting white marking paint as a paint block that constitutes the marking. Note that the white marking paint refers to a paint that constitutes a white marking or a yellow marking formed on the road with a dotted line or a solid line along a direction with which the road extends in order to divide an area with respect to the road width direction. The extracted white paints are connected in a travelling direction of the own vehicle 60, thereby extracting lane markings present extending along the travelling direction of the own vehicle 60.

The object recognition unit 45 recognizes objects in the vicinity of the own vehicle 60 based on the periphery monitoring information acquired from the periphery monitoring apparatus 20. Specifically, the object recognition unit 45 identifies an object based on a size of body, its moving speed or the like and recognizes the object. The object recognition unit 45 performs an object recognition process for an object detected in at least either the rear side or laterally rear side of the own vehicle.

The lane change detection unit 46 detects a lane change of the own vehicle 60. The lane change can be detected based on information related to the lane marking on the road recognized by the white marking recognition unit 44, information related to an on-road structure acquired by detecting a structure in the vicinity of the road and a map information capable of being acquired by the reception unit 26. For example, the lane change detection unit 46 may be configured to detect a lane change of the own vehicle 60 based on a change in the distance between the lane marking of the road where the own vehicle 60 travels which is recognized by the white marking recognition unit 44 and the own vehicle 60.

Further, for example, the lane change detection unit 46 may be configured to detect a lane change of the own vehicle 60 based on a change in the distance between an on-road structure such as a guardrail or a road fence installed on a road shoulder and the own vehicle 60.

Also, for example, the lane change detection unit 46 may be configured to detect a lane change of the own vehicle 60 based on the map information received by the reception apparatus 24. Specifically, the lane change detection unit 46 may acquire a road where the own vehicle travels and a shape of the traffic lane from the map information, compares the acquired the road and the shape of the traffic lane with the travelling locus of the own vehicle 60, and when the travelling locus of the own vehicle 60 exceeds the traffic lane acquired from the map information, the lane change detection unit 46 may determine that the own vehicle 60 change the traffic lane.

The lane change detection unit 46 may be configured to be capable of detecting a lane change based on a plurality of pieces of information and may be configured to detect a lane change with acquired information which is prioritized. For example, in the case where the lane change detection unit 46 is able to detect a lane change based on information related to a lane marking, information related to an on-road structure and map information, when it is impossible to detect the lane change based on the information related to the lane marking, the lane change detection unit 46 may detect a lane change based on the information related to the on-road structure and the map information.

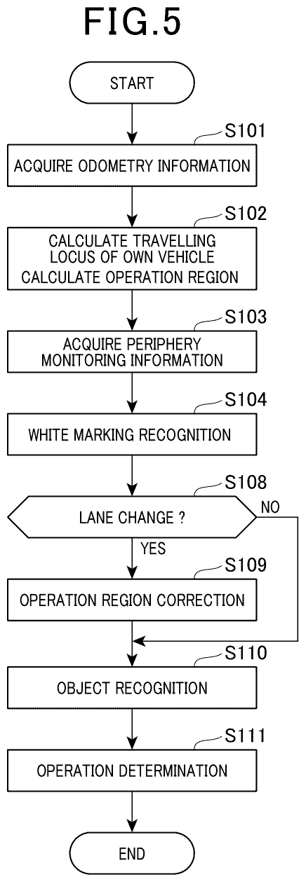

The operation region correction unit 47 corrects the operation region based on lane information related to a traffic lane after the lane change of the own vehicle 60 when the lane change detection unit 46 detects a lane change of the own vehicle. The lane information refers to information related to a traffic lane where the own vehicle 60 travels, including information related to lane marking, information related to on-road structure and map information. The correction of the operation region may be performed after completing the lane change or may be successively performed during a period from when the lane change is started to when the lane change is completed. In the travelling locus of the own vehicle 60 shown in FIG. 4, when detecting a lane change in a period from when the own vehicle 60 travels from the point A12 to the point A1, the operation region 71R is corrected to be an operation region 72R based on a shape of the traffic lane where the own vehicle 60 currently travels. As shown in FIG. 4, the operation region 72R refers to an operation region having a substantial rectangular shape extending in a direction orthogonal to the current horizontal line L0 of the own vehicle 60.

The operation region 72R after being corrected may have a shape extending along a shape of the traffic lane where the own vehicle 60 travels. For example, the operation region may be changed based on the position of the lane marking that divides left and right edges of the adjacent lane such that the operation region is positioned within an adjacent lane of the lane where the own vehicle 60 currently travels. Also, as shown in FIG. 4, points A1 to A12, B1 to B12 and C12 to C12 which indicate past travelling locus and the operation region of the own vehicle 60 are caused to move along corresponding horizontal lines L1 to L12, whereby the operation region 71R may be corrected to be an operation region 72R. An amount of movement of each point (correction quantity) can be calculated based on a change amount of a distance between the lane marking of the road where the own vehicle 60 travels which is recognized by the white marking recognition unit 44 and the own vehicle 60. The respective points are caused to move based on the correction quantity thus calculated, whereby the operation region can be corrected to the operation region 72R having a shape along the shape of the lane marking where the own vehicle 60 currently travels. As shown in FIG. 4, the points A1 to A12, B1 to B12 and C1 to C12 can be moved to be on a line in a traffic lane direction parallel to a direction extending in the traffic lane where the own vehicle 60 currently travels from the points A0, B0 and C0 on the horizontal line L0.

The points A22 to A32 refer to points where the points A2 to A12 are moved to be on a line in a traffic lane direction passing through the point A0. The points B22 to B32 refer to points where the points B2 to B12 are moved to be on a line in a traffic lane direction passing through the point B0. The points C22 to C32 refer to points where the points C2 to C12 are moved to be on a line in a traffic lane direction passing through the point C0. The points A0, A1, A22 to A32 are on the line in the traffic lane direction passing through the point A0. Each of the points A0, A1, A22 to A32 is a cross-point between corresponding one in the horizontal lines L1 to L12 and the line in the traffic lane direction passing through the point A0. The point B0, B1, B22 to B32 are on the line in the traffic lane direction passing through the point B0. Each of the points B0, B1, B22 to B32 is a cross-point between corresponding one of the horizontal lines L1 to L12 and the line in the traffic lane direction passing through the point B0. The points C0, C1, C22 to C32 are on the line in the traffic lane direction passing through the point C0. Each of the points C0, C1, C22 to C32 is a cross-point between corresponding one of the horizontal lines L1 to L12 and the line in the traffic lane direction passing through the point C0.

The operation region 72R refers to a region surrounded by the points B0, B1, B22 to B32 and the points C0, C1, C22 to C32.

The operation region correction unit 47 may preferably be configured to correct the operation region based on at least captured image information. The captured image information is a periphery monitoring information capable of being acquired by the camera apparatus 22. The camera apparatus 22 accurately detects the shape of the traffic lane where the own vehicle 60 actually travels, whereby the operation region can be corrected appropriately corresponding to the actual shape of the traffic lane. Further, the operation region correction unit 47 may be configured to correct the operation region based on at least the map information. The map information is periphery monitoring information capable of being acquired by the reception unit 24.

The operation region correction unit 47 may preferably be configured to correct the operation region based on at least lane marking information. The marking information refers to information about lane marking of the road where the own vehicle 60 travels. The lane marking information can be acquired by calculating based on the captured image information acquired from the camera apparatus 22. Also, the lane marking information may be included in the map information acquired by the reception apparatus 24.

The operation region correction unit 47 may be configured not to correct the operation region in the case where the reliability of the lane marking is low. Moreover, in the case where the periphery monitoring information includes at least lane marking information as information of the lane marking of the road where the own vehicle travels and information other than the lane marking information, the operation region correction unit 47 may be configured to correct the operation region based on information other than the lane marking information.

The operation determination unit 48 commands the control object 50 to perform a driving assist control when the object recognition unit 45 detects an object in the operation region. As the driving assist control, for example, a collision mitigation control or a collision avoidance control such as a notification command to the alert apparatus, an automatic brake command to the brake apparatus and a steering avoidance command to the steering apparatus, and a control for activating a safety apparatus such as an automatic lock command of vehicle doors may be performed. The operation determination unit 48 may be configured to determine various operations of the driving assist system such as a secondary collision avoidance brake operation that mitigates a secondary damage with an automatic brake when a rear end collision is unable to be avoided, a hazard blinking operation that blinks a hazard lamp for notifying a following vehicle of a risk of a rear end collision, a blind-spot monitoring operation that detects vehicles or the like present in a blind spot and notifies the driver of the vehicle existing in the blind spot, an alert operation to avoid accidents (e.g. contacting pedestrians) during a left or right turn, a trailer blind spot monitoring that expands an operation region when automatically detecting a coupling of a trailer and an alighting alert operation for alerting a driver when they open a door for alighting when detecting a vehicle or the like approaching the own vehicle 60.

The operation region correction unit 47 corrects the operation region based on the lane marking information related to the traffic lane after the lane change of the own vehicle 60, when the lane change detection unit 46 detects a lane change of the own vehicle 60. Hence, the operation determination unit 48 is able to appropriately determine an activation of various driving assist operations of the own vehicle 60 based on the operation region which is appropriately set.

In the case where the own vehicle 60 meanders due to a lane change as shown in FIGS. 3 and 4, although other vehicle 66 is not travelling on an adjacent lane of the traffic lane of the own vehicle 60 after the lane change (e.g. other vehicle 66 is travelling on further right-lane of the adjacent lane positioned in a right side of the own vehicle 60), since the other vehicle 66 enters the operation region 71R, a driving assist operation such as a control of avoiding a collision between the own vehicle 60 and the other vehicle 66 is executed. In this respect, the operation region 72R is corrected to be a region extending in a direction of the traffic lane where the own vehicle 60 currently travels. Since the other vehicle 66 does not enter the operation region 72R, a driving assist operation such as a collision avoidance control is prevented from being executed.

On the other hand, when the own vehicle 60 meanders along the shape of the traffic lane, the lane change is not detected. Hence, the operation region 71R is not corrected. As a result, when the other vehicle 66 travelling on an adjacent lane of the traffic lane where the own vehicle 50 travels, enters the operation region 71R, a driving assist operation such as a control of avoiding a collision between the own vehicle 60 and the other vehicle 66 is performed.

An appropriate correction of the operation region contributes an appropriate determination of operations even in the above-described various operations of the driving assist system. For example, when the ECU 40 is applied to the hazard blinking system, it can avoid a case where a hazard blinking operation is executed although alert notification is not required. This is useful for countries or regions where a hazard blinking is legally regulated.

The ECU 40 executes a driving assist program as a computer program stored in a memory device such as ROM, thereby detecting an object existing in the operation region and controlling the vehicle.

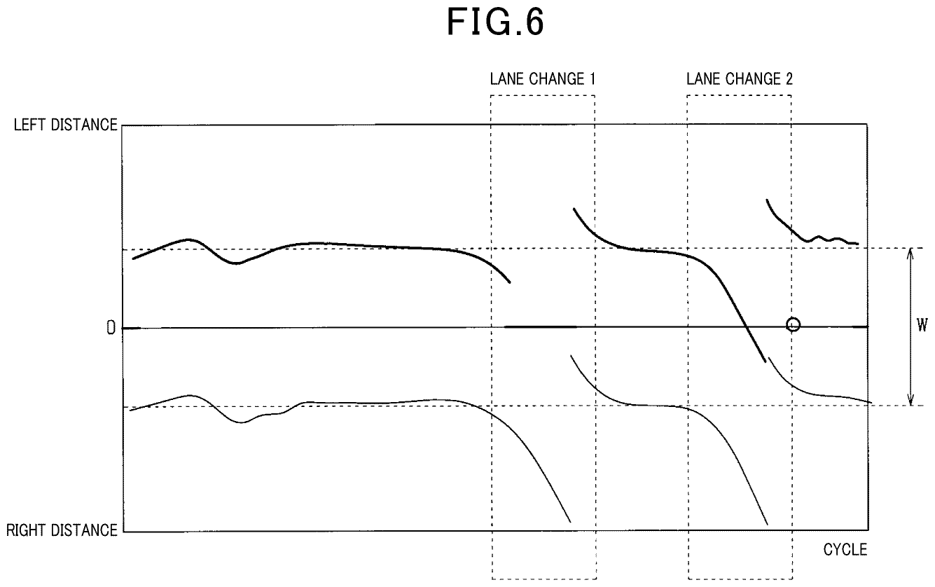

FIG. 5 shows a flowchart of a driving assist process executed by the ECU 40. The processes described in the flowchart are repeatedly executed at predetermined intervals.

Firstly, at step S101, the process acquires odometry information. For example, the process appropriately acquires detection values of various sensors from the vehicle speed sensor 31, the steering angle sensor 32 and the yaw rate sensor 33 and acquires the odometry information related to a travelling state of the own vehicle 60. The acquired odometry information is appropriately stored in the ECU 40. The ECU 40 stores the odometry information correlating the location of the own vehicle 60 with the odometry information. Then, the process proceeds to step S102.

At step S102, the process calculates an own-vehicle travelling locus as a travelling locus of the own vehicle 60 based on the odometry information stored in the ECU 40. For example, the process couples an actually-measured locations of the own vehicle 60 which are actually measured in the past with estimated locations between actually-measured locations adjacently positioned which are estimated in accordance with the odometry information, thereby calculating the own-vehicle travelling locus. For example, the locus obtained by coupling the points A0 to A12 shown in FIG. 3 is calculated as the own-vehicle travelling locus. Then, the process calculates, based on the calculated own-vehicle travelling locus, an operation region in an adjacent region within an adjacent lane of the own vehicle 60. For example, the process calculates, based on the odometry information, the points B0 to B12 and the points C0 to C12 shown in FIG. 3, and proceeds to step S103.

At step S103, the process acquires the periphery monitoring information. The periphery monitoring information is acquired from at least one of the radar apparatus 21, the camera apparatus 22, the sonar apparatus 23 and the reception apparatus 24 which are included in the periphery monitoring apparatus 20. Then, the process proceeds to step S104.

At step S104, the process executes a white marking recognition process. Specifically, the process recognizes, based on the periphery monitoring information acquired at step S103, a lane marking of the road where the own vehicle 60 travels, generates lane marking information of the lane marking of the road where the own vehicle 60 travels, and stores the generated lane marking information as a part of periphery monitoring information. Specifically, for example, the process extracts edge points from substantially entire region of an image captured by the camera apparatus 22, connects extracted edge points, thereby extracting white paint as a block of paints that constitutes the lane marking. The extracted white paints are connected in the travelling direction of the own vehicle 60, thereby recognizing the lane marking extending in the travelling direction of the own vehicle 60. Thereafter, the process proceeds to step S108.

At step S108, the process determines whether a lane change of the own vehicle 60 occurs. For example, the process detects a lane change of the own vehicle 60 based on the lane marking of the road where the own vehicle 60 travels which is detected at step S104 and a change in a distance to the own vehicle 60.

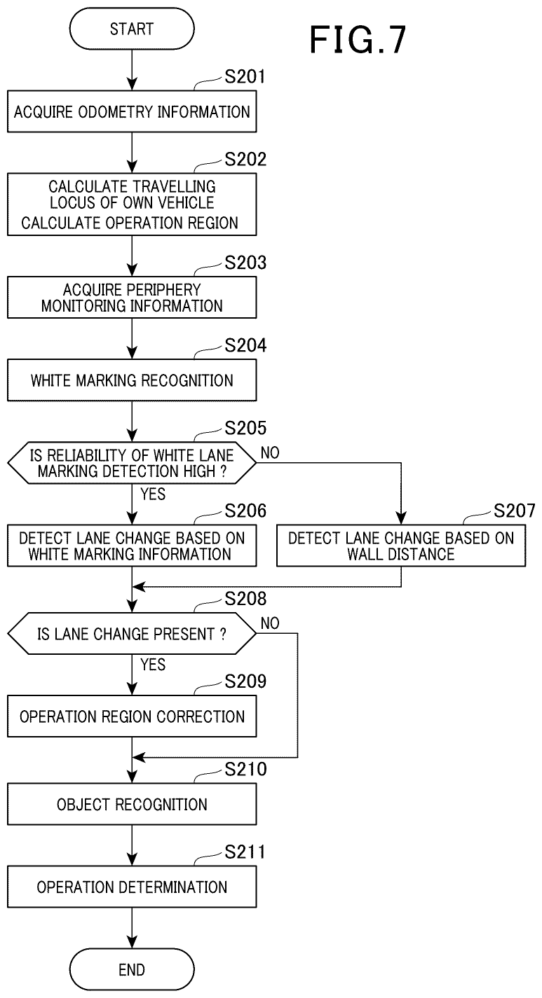

FIG. 6 shows a lane marking recognized in a lateral side of the own vehicle 60 and a change in a distance to the own vehicle 60. Note that left side distance in the vertical axis indicates a distance between the own vehicle 60 and the lane marking in the left side of the own vehicle 60, and right side distance in the vertical axis indicates a distance between the own vehicle 60 and the lane marking in the right side of the own vehicle 60. The horizontal axis indicates a control cycle. The distance W in FIG. 6 indicates a sum of the left distance and the right distance when the left distance and the right distance rarely change, which refers to a lane width of the traffic lane where the own vehicle 60 travels.

Note that lane change 1 and lane change 2 in FIG. 6 indicates that the own vehicle 60 changes the lane from the current traffic lane to a left side lane of the current traffic lane. In the lane change 1, the left side distance gradually decreases and the right side distance increases, thereafter the left side distance and the right side distance intermittently become zero, and then the left side distance intermittently increases and the right side distance decreases. In the lane change 2, the left side distance gradually decreases and the right side distance increases, thereafter a decrease in the left side distance turns to an increase in the right side distance, and when the left side distance turns to the right side distance, the left side distance intermittently increases. In this state, the own vehicle 60 approaches the left-side lane for the lane change and passes over the left-side marking, whereby the left and right lane markings are changed. That is, the lane marking recognized as a left-side lane before the lane change is changed to be recognized as a right side lane of the own vehicle after the lane change. Also, the lane marking recognized as a left side lane before the lane change is changed to be recognized as a right side lane of the own vehicle. When a lane change is present, the process proceeds to step S109 and when a lane change is not present, the process proceeds to step S110 without performing step S109.

At step S109, the process corrects, based on the lane information related to the traffic lane where the own vehicle 60 travels after the lane change, the operation region calculated at step S102. For example, the process calculates the operation region 71R shown in FIG. 3 at step S102, and when determined that the own vehicle 60 changes the lane to the left-side adjacent lane at step S108, the process corrects, based on the shape of the traffic lane where the own vehicle 60 currently travels, the operation region to be like the operation region 72R shown in FIG. 4. The process calculates, based on the lane marking of the road where the own vehicle 60 travels which is recognized at step S104 and a change amount of the distance to the own vehicle 60, the points A1 to A12 on the travelling locus of the own vehicle, the points B1 to B12 and C1 to C12 that define the operation region 71R shown in FIG. 3. For example, in FIG. 6, a constant left distance WL and a constant right distance WR are defined in the case where the left distance and the right distance rarely change (i.e. W=WL+WR), and the process sets the correction quantity such that the larger the difference between the observed left distance XL and the constant left distance WL or larger the difference between the observed right distance XR and the constant right distance WR, the larger the correction quantity is. The respective points are caused to move based on the correction quantity thus calculated, whereby the operation region can be corrected to the operation region 72R having a shape extending along a shape of the traffic lane where the own vehicle 60 currently travels. Then, the process proceeds to step S110.

At step S110, an object recognition process is executed for an object detected in the vicinity of the own vehicle based on the periphery monitoring information acquired at step 103. For example, the process recognizes moving bodies such as cars, motor cycles and pedestrians, and stationary object such as on-road structure. Then, the process proceeds to step S111.

At step S111, when the object recognized at step S110 is present in the operation region, the process determines whether a driving assist control needs to be activated based on a predetermined condition. When the process determines that lane change is not present at step S108, the process determines whether a driving assist control needs to be activated when an object is present in the operation region 71R. In the case where the process determines that lane change is present at step S108 and the operation region is corrected at step S109, the process determines whether the driving assist control needs to be activated when an object is present in the operation region 72R. When determined that the driving support control needs to be activated, the process commands the control object 50, thereby executing the driving assist control.

As described above, processes for the driving assist program include a travelling locus calculation step (corresponds to step S102), an operation region calculation step (corresponds to step S102), a lane change detection step (corresponds to step S108), an operation region correction step (corresponds to step S109) and an operation determination step (corresponds to step S111). The travelling locus calculation step calculates a travelling locus of the own vehicle. The operation region calculation step calculates an operation region in the vicinity of the own vehicle based on the travelling locus of the own vehicle calculated at the travelling locus calculation step. The lane change detection step detects a lane change of the own vehicle. The operation region correction step corrects the operation region when a lane change of the own vehicle is detected at the lane change detection step, based on the lane information related to the traffic lane of the own vehicle after the lane change. The operation determination step determines, based on the periphery monitoring information, whether the driving assist operation needs to be activated when an object is detected in the operation region.

According to the driving assist process of the first embodiment, as shown in steps S101 and S102, the process calculates a travelling locus of the own vehicle 60 based on the odometry information acquired from the odometry sensors 30, and calculates the operation region 71R in the vicinity of the own vehicle 60 based on the calculated travelling locus of the own vehicle 60. The travelling locus of the own vehicle 60 can be accurately calculated using the estimated position of the own vehicle which is estimated using the odometry information in addition to the actual measurement position of the own vehicle 60, and further the operation region 71R can be accurately calculated.

Also, as shown in steps S103, S104 and S108, the process detects a lane change of the own vehicle 60 based on the periphery monitoring information acquired from the periphery monitoring apparatus 20. When the lane change is detected, as shown in step S109, the process corrects, based on the lane information related to the traffic lane of the own vehicle 60 after the lane change, the operation region to be like the operation region 72R for example, thereafter the process determines whether the driving assist operation of the own vehicle 60 needs to be activated for an object in the operation region (operation region 72R) as shown in steps S110 and S111. Since the operation region 72R is corrected to be in a region extending in a direction of the traffic lane where the own vehicle 60 currently travels and other vehicle 66 does not enter the operation region 72R, a collision avoidance control or the like can be prevented from being performed.

Further, when the lane change is not detected, the process proceeds to steps S110 and S111 without executing step S109, and determines whether a driving assist operation of the own vehicle 60 needs to be activated for an object existing in the operation region (operation region 71). For example, even when the own vehicle 60 meanders as shown in FIG. 3, if the own vehicle meanders along the lane shape, since a lane change is not detected, the operation region 71R is not corrected. Hence, when other vehicle 66 travelling on the adjacent lane of the traffic lane of the own vehicle 60 enters the operation region 71R, a driving assist operation can be appropriately performed to avoid a collision between the own vehicle 60 and other vehicle 66.

### Second Embodiment

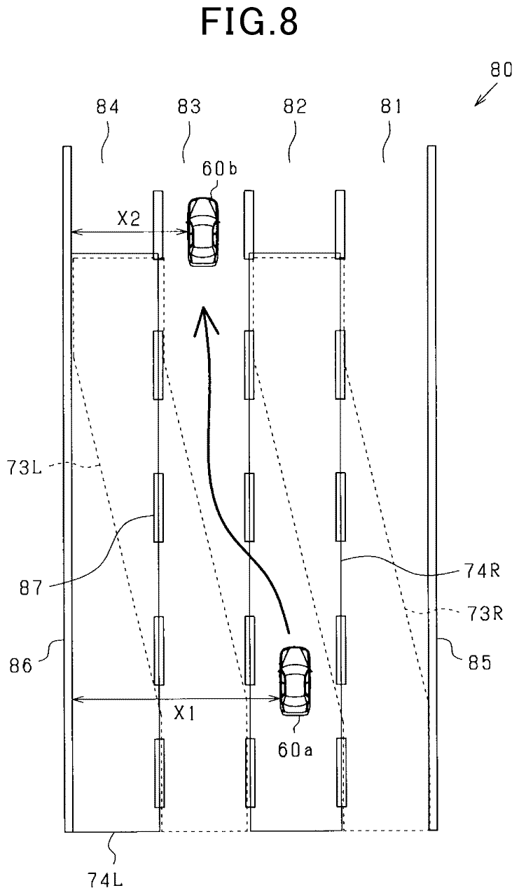

FIG. 7 shows a flowchart showing a driving assist process according to a second embodiment. As shown in steps S204 to S207, the driving assist process shown in FIG. 7 differs from the driving assist process shown in FIG. 5 in that a method of detecting lane change is selected based on a reliability of the white marking recognition. Since the respective processes shown in steps S201 to S203 and S208 to S211 are similar to steps S101 to S103 and S108 to S111, explanation thereof will be omitted.

After acquiring the periphery monitoring information at step S203, the process proceeds to step S204 and acquires white marking information, that is, lane marking information. Subsequently, at step S205, the process determines whether the reliability of the lane marking information acquired at step S204 is high. Specifically, the process determines whether the reliability of the lane marking information is higher than or equal to a predetermined threshold. When the reliability is higher than or equal to the predetermined threshold, the process determines that the white marking has high reliability, proceeds to step S206 and performs a lane change detection based on the lane marking information. When the reliability is less than the predetermined threshold, the process determines that the reliability of the white marking is low, proceeds to step S207 and performs a lane change detection based on the periphery monitoring information other than the lane marking information. Specifically, for example, the process detects a lane change of the own vehicle 60 based on a change in a wall distance as a distance between the own vehicle 60 and a road wall.

FIG. 8 shows a case where the own vehicle 60 changes a lane from a traffic lane 82 to a traffic lane 83 on a road 80 having traffic lanes 81 to 84. The own vehicle 60a indicates a location of the own vehicle 60 before the lane change and the own vehicle 60b indicates a location of the own vehicle 60 after the lane change. At both lateral edges of road 80, road walls 85 and 86 are installed and respective traffic lanes 81 to 84 are divided by lane markings 87. A distance from the own vehicle 60a to the road wall 86 in the left side of the own vehicle 60a is X1 and a distance from the own vehicle 60b to the road wall 86 in the left side of the own vehicle 60b is X2. A lane change can be detected when detecting the distance to the road wall changes from X1 to X2.

After completing steps S206 or S207, the process proceeds to step S208. The process proceeds to subsequent step S209, when determined at step S208 that a lane change is present. The process proceeds to step S210, when determined at step S209 that no lane change is present without performing step S209.

At step S209, the process corrects an operation region calculated at step S202 based on lane information related to a traffic lane of the own vehicle 60 after the lane change. For example, at step S202, an operation region 73R and an operation region 73L are calculated shown in FIG. 8, and when determined at step S208 that the own vehicle 60 changes the lane to a left-side adjacent lane, the process corrects, based on the shape of the traffic lane where the own vehicle 60 currently travels, the operation region to be like the operation regions 74R and 74L

When detecting a lane change based on the lane marking information, at step S209, similar to step S109 shown in FIG. 5, the process calculates the correction quantity of the operation region based on a change amount of a distance between the lane marking of the road where the own vehicle 60 travels and the own vehicle 60. When detecting a lane change of the own vehicle 60 based on a change in the wall distance, at step S209, the process corrects the correction quantity of the operation region based on the change amount of the wall distance. Hereinafter, similar to the flowchart shown in FIG. 5, the process terminates the driving assist process after performing the steps S210 to S211.

According to the driving assist process of the second embodiment, as shown in steps S205 to S07, when the reliability of the lane marking information is low, the process corrects the operation region based on information other than the lane marking information. The information of a location and a shape of the lane marking included in the lane marking information expresses the shape of the traffic lane where the own vehicle 60 travels more accurately compared to the information other than the lane marking information. Hence, when the reliability of the white marking is high, the lane change is detected preferentially using the lane marking information. Thus, the shape of the traffic lane where the own vehicle 60 travels can be accurately detected. On the other hand, when the reliability of the white marking is low, the lane change is detected using information other than the lane marking information. Thus, even in a case where the accuracy of white lane recognition is lowered due to a lower accuracy of the camera apparatus 22, the shape of the traffic lane where the own vehicle 60 travels can be detected based on the information other than the lane marking information, thereby detecting the lane change of the own vehicle 60.

In the flowchart shown in FIG. 7, when determined at step S205 that the reliability of the lane marking information is low, the process proceeds to step S207 and detects the lane change based on the information other than the lane marking information. However, it is not limited thereto. For example, when detecting that the reliability of the lane marking information is low, the operation region may not be corrected. Specifically, at step S205, when determined that the reliability of the lane marking information is low, the process may proceed to step S210. Also, when determined at step S205 that the reliability of the lane marking information is low, a reliability of information other than the lane marking information may be evaluated. The lane change may be detected using information having high reliability among information other than the lane marking information. The operation region may not be corrected when none of information has sufficient high reliability or information other than the lane marking information cannot be utilized.

According to the above-described embodiments, it is exemplified that operation regions 71R and 72R having a beltlike-shape are set in a laterally right rear side of the own vehicle 60. However, it is not limited thereto. For the operation region calculated by the operation region calculation unit 43 and the operation region corrected by the operation region correction unit 47, their sizes, shapes and positions are modified depending on specific driving support such as a notification command to the alert apparatus, an automatic brake command to a brake apparatus, a collision mitigation control or a collision avoidance control, an activation control for a safety apparatus, a secondary collision avoidance brake, a blinking-hazard for notifying the following vehicle of a risk of a rear-end collision by blinking the hazard lamp, a blind spot monitoring that detects vehicles existing in a blind sport and alerts the driver, an alert operation to avoid accident (e.g. contacting pedestrians) during a left or right turn, a trailer blind-spot monitoring that expands an operation region when automatically detecting a coupling of a trailer and an alighting alert operation for alerting a driver that opens a door for the alighting when detecting a vehicle or the like approaching the own vehicle 60.

According to the above-described embodiments, the following effects and advantages can be obtained.

The ECU 40 functions as a driving assist apparatus that performs a driving assist operation of the own vehicle 60 based on the periphery monitoring information of the own vehicle 60 acquired from the periphery monitoring apparatus 20. The ECU 40 is provided with a travelling locus calculation unit 42, an operation region calculation unit 43, a white marking recognition unit 44, a lane change detection unit 46, an operation region correction unit 47 and an operation determination unit 48.

The travelling locus calculation unit 42 calculates a travelling locus of the own vehicle 60. The operation region calculation unit 43 calculates an operation region in the vicinity of the own vehicle 60 (e.g. operation region 71R) based on the travelling locus of the own vehicle 60 calculated by the travelling locus calculation unit 42. The lane change detection unit 46 detects a lane change of the own vehicle 60. When the lane change detection unit 46 detects a lane change of the own vehicle 60, the operation region correction unit 47 corrects, based on the lane information related to the traffic lane of the own vehicle 60 after the lane change, the operation region to be like the operation region 72R for example. The operation determination unit 48 determines whether the driving assist operation of the own vehicle 60 needs to be activated, when an object is detected in an operation region (operation region 71R or operation region 72R). According to the above-described respective units in the ECU 40, when the travelling locus of the own vehicle does not fit the lane shape, the operation region can be appropriately changed. For example, an operation region which is set in a region having a low-risk to the own vehicle 60 (e.g. operation region 71R) such as a case where a region set in an adjacent lane before the lane change of the own vehicle 60 is changed to a region set in a different lane other than the adjacent lane after the lane change, can be changed to be an operation region fit to the lane shape after the lane change of the own vehicle 60 (e.g. operation region 72R). As a result, the operation determination unit 48 can be prevented from performing a determination of whether a driving assist operation needs to be activated even in a state where the operation region is set in a region having a low risk to the own vehicle 60.

The periphery monitoring information may include information of an image captured by the camera apparatus 22 for a region in the vicinity of the own vehicle 60. In this case, it may preferably be configured to correct the operation region based on at least the captured information. Hence, the camera apparatus 22 accurately detects the lane shape of the traffic lane where the own vehicle 60 actually travels, whereby the operation region can be corrected more appropriately fitting with the actual lane shape.

The periphery monitoring information may include map information received by the reception apparatus 24. In this case, the operation region correction unit 47 may be configured to correct the operation region based on at least map information.

The periphery monitoring information may include lane marking information related to a lane marking of the road where the own vehicle travels. In this case, the operation region correction unit 47 may preferably be configured to correct the operation region based on at least the lane marking information.

The operation region correction unit 47 may be configured not to correct the operation region when the reliability of the lane marking information is low. Also, when the periphery monitoring information includes at least lane marking information as information related to the lane marking of the road where the own vehicle travels and information other than the lane marking information, the operation region correction unit 47 may be configured to correct the operation region based on the information other than the lane marking information when the reliability of the lane marking information is low.

The travelling locus calculation unit 42 may preferably be configured to calculate the travelling locus of the own vehicle 60 based on the odometry information indicating the operation state of the own vehicle 60. Since the location of the own vehicle 60 can be calculated with interpolating based on the odometry information, the travelling locus of the own vehicle can be accurately calculated.

The driving assist program applied to the ECU 40 includes a travelling locus calculation step that calculates the travelling locus of the own vehicle, an operation region calculation step that calculates an operation region in the vicinity of the own vehicle based on the travelling locus calculated by the travelling locus calculation step, a lane change detection step that detects a lane change of the own vehicle, an operation region correction step that corrects, when a lane change of the own vehicle is detected by the lane change detection step, the operation region, based on the lane information related to the traffic lane of the own vehicle after the lane change, and an operation determination step that determines whether the driving assist operation needs to be activated, when an object is detected in the operation region, based on the periphery monitoring information.

The control unit and method thereof disclosed in the present disclosure may be accomplished by a dedicated computer constituted of a processor and a memory programmed to perform one or more functions embodied by computer programs. Alternatively, the control unit and method thereof disclosed in the present disclosure may be accomplished by a dedicated computer provided by a processor configured of one or more dedicated hardware logic circuits. Further, the control unit and method thereof disclosed in the present disclosure may be accomplished by one or more dedicated computer where a processor and a memory programmed to perform one or more functions, and a processor configured of one or more hardware logic circuits are combined. Furthermore, the computer programs may be stored, as instruction codes executed by the computer, into a computer readable non-transitory tangible recording media.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or fewer elements of those various combinations are within the range and technical scope of the present disclosure.

Hereinafter, significant configurations obtained from the above-described respective embodiments will be described.

### Configuration 1

A driving assist apparatus (40) that performs, in accordance with periphery monitoring information of an own vehicle (60) acquired from a periphery monitoring apparatus (20), a driving assist operation of the own vehicle, the driving assist apparatus comprising:
a travelling locus calculation unit (42) that calculates a travelling locus of the own vehicle;
an operation region calculation unit (43) that calculates an operation region in the vicinity of the own vehicle, based on the travelling locus of the own vehicle calculated by the travelling locus calculation unit;
a lane change detection unit (46) that detects a lane change of the own vehicle;
an operation region correction unit (47) that corrects, when the lane change detection unit detects the lane change of the own vehicle, the operation region based on lane information related to a traffic lane after the lane change of the own vehicle; and
an operation determination unit (48) that determines, when an object is detected in the operation region, whether the driving assist operation needs to be activated based on the periphery monitoring information.

### Configuration 2

The driving assist apparatus according to configuration 1, wherein
the periphery monitoring information includes an image information of an image in the vicinity of the own vehicle captured by a camera apparatus (22); and
the operation region correction unit corrects the operation region based on at least the image information.

### Configuration 3

The driving assist apparatus according to configuration 1 or 2, wherein
the periphery monitoring information includes map information received by a reception apparatus (24); and
the operation region correction unit corrects the operation region based on at least the map information.

### Configuration 4

The driving assist apparatus according to any one of configurations 1 to 3, wherein
the periphery monitoring information includes lane marking information as information related to a lane marking of a road where the own vehicle travels; and
the operation region correction unit corrects the operation region based on at least the lane marking information.

### Configuration 5

The driving assist apparatus according to configuration 4, wherein
the operation region correction unit does not correct the operation region when a reliability of the lane marking information is low.

### Configuration 6

The driving assist apparatus according to any one of configurations 1 to 3, wherein
the periphery monitoring information at least includes lane marking information as information of a lane marking of a road where the own vehicle travels and information other than the lane marking information; and
the operation region correction unit corrects the operation region based on the information other than the lane marking information, when a reliability of the lane marking information is low.

### Configuration 7

The driving assist apparatus according to any one of configurations 1 to 6, wherein
the travelling locus calculation unit calculates the travelling locus of the own vehicle based on odometry information indicating an operation state of the own vehicle.

### Configuration 8

A driving assist program stored in a non-transitory tangible computer readable media executed by a computer, being applied to a driving assist apparatus that performs, based on periphery monitoring information of an own vehicle acquired from a periphery monitoring apparatus, a driving assist of the own vehicle, the driving assist program comprising:
a travelling locus calculation step that calculates a travelling locus of the own vehicle;
an operation region calculation step that calculates, based on the travelling locus of the own vehicle calculated by the travelling locus calculation step, an operation region in the vicinity of the own vehicle;
a lane change detection step that detects a lane change of the own vehicle;
an operation region correction step that corrects, when the lane change detection step detects the lane change of the own vehicle, the operation region based on lane information related to a traffic lane after the lane change of the own vehicle; and
an operation determination step that determines, when an object is detected in the operation region, whether a driving assist operation needs to be activated based on the periphery monitoring information.

### Conclusion

In light of the above-described circumstances, the present disclosure provides a technique capable of appropriately changing the operation region when the travelling locus of the own vehicle is not along the shape of the traffic lane.

The present disclosure provides a driving assist apparatus that performs, in accordance with periphery monitoring information of an own vehicle acquired from a periphery monitoring apparatus, a driving assist operation of the own vehicle.

The driving assist apparatus includes: a travelling locus calculation unit that calculates a travelling locus of the own vehicle; an operation region calculation unit that calculates an operation region in the vicinity of the own vehicle, based on the travelling locus of the own vehicle calculated by the travelling locus calculation unit; a lane change detection unit that detects a lane change of the own vehicle; an operation region correction unit that corrects, when the lane change detection unit detects the lane change of the own vehicle, the operation region based on lane information related to a traffic lane after the lane change of the own vehicle; and an operation determination unit that determines, when an object is detected in the operation region, whether the driving assist operation needs to be activated based on the periphery monitoring information.

According to the present disclosure, when the lane change of the own vehicle is detected, the operation region correction unit is able to correct the operation region based on lane information related to a traffic lane after the lane change of the own vehicle. Hence, when the travelling locus of the own vehicle does not fit the lane shape, the operation region can be appropriately changed. For example, an operation region which is set in a region having a low-risk to the own vehicle such as a case where a region set in an adjacent lane before the lane change of the own vehicle is changed to a region set in a different lane other than the adjacent lane after the lane change, can be changed to be an operation region fit to the lane shape after the lane change of the own vehicle. As a result, the operation determination unit can be prevented from executing a determination whether a driving assist operation needs to be activated even in a state where the operation region is set in a region having a low risk to the own vehicle.

The present disclosure may provide a driving assist program stored in a non-transitory tangible computer readable media executed by a computer, being applied to a driving assist apparatus that performs, based on periphery monitoring information of an own vehicle acquired from a periphery monitoring apparatus, a driving assist of the own vehicle. The driving assist program includes: a travelling locus calculation step that calculates a travelling locus of the own vehicle; an operation region calculation step that calculates, based on the travelling locus of the own vehicle calculated by the travelling locus calculation step, an operation region in the vicinity of the own vehicle; a lane change detection step that detects a lane change of the own vehicle; an operation region correction step that corrects, when the lane change detection step detects the lane change of the own vehicle, the operation region based on lane information related to a traffic lane after the lane change of the own vehicle; and an operation determination step that determines, when an object is detected in the operation region, whether a driving assist operation needs to be activated based on the periphery monitoring information.

According to the above driving assist program, similar to the driving assist apparatus, when the travelling locus of the own vehicle does not fit the lane shape, the operation region can be appropriately changed. Further, an operation region which is set in a region having a low-risk to the own vehicle can be changed to be an operation region fit to the lane shape after the lane change of the own vehicle. The operation determination unit can be prevented from executing a determination whether a driving assist operation needs to be activated even in a state where the operation region is set in a region having a low-risk to the own vehicle.

What is claimed is:

1. A driving assist apparatus that performs, in accordance with periphery monitoring information of an own vehicle acquired from a periphery monitoring apparatus, a driving assist operation of the own vehicle, the driving assist apparatus comprising:
a travelling locus calculation unit that calculates a travelling locus of the own vehicle;
an operation region calculation unit that calculates an operation region in the vicinity of the own vehicle, based on the travelling locus of the own vehicle calculated by the travelling locus calculation unit;
a lane change detection unit that detects a lane change of the own vehicle;
an operation region correction unit that corrects, when the lane change detection unit detects the lane change of the own vehicle, the operation region based on lane information related to a traffic lane after the lane change of the own vehicle; and
an operation determination unit that determines, when an object is detected in the operation region, whether the driving assist operation needs to be activated based on the periphery monitoring information.

2. The driving assist apparatus according to claim 1, wherein
the periphery monitoring information includes image information of an image in the vicinity of the own vehicle captured by a camera apparatus; and
the operation region correction unit corrects the operation region based on at least the image information.

3. The driving assist apparatus according to claim 1, wherein
the periphery monitoring information includes map information received by a reception apparatus; and
the operation region correction unit corrects the operation region based on at least the map information.

4. The driving assist apparatus according to claim 1, wherein
the periphery monitoring information includes lane marking information as information related to a lane marking of a road where the own vehicle travels; and
the operation region correction unit corrects the operation region based on at least the lane marking information.

5. The driving assist apparatus according to claim 4, wherein
the operation region correction unit does not correct the operation region when a reliability of the lane marking information is low.

6. The driving assist apparatus according to claim 1, wherein
the periphery monitoring information at least includes lane marking information as information of a lane marking of a road where the own vehicle travels and information other than the lane marking information; and
the operation region correction unit corrects the operation region based on the information other than the lane marking information, when a reliability of the lane marking information is low.

7. The driving assist apparatus according to claim 1, wherein
the travelling locus calculation unit calculates the travelling locus of the own vehicle based on odometry information indicating an operation state of the own vehicle.

8. A driving assist program stored in a non-transitory tangible computer readable media executed by a computer, being applied to a driving assist apparatus that performs, based on periphery monitoring information of an own vehicle acquired from a periphery monitoring apparatus, a driving assist operation of the own vehicle, the driving assist program comprising:
a travelling locus calculation step that calculates a travelling locus of the own vehicle;
an operation region calculation step that calculates, based on the travelling locus of the own vehicle calculated by the travelling locus calculation step, an operation region in the vicinity of the own vehicle;
a lane change detection step that detects a lane change of the own vehicle;
an operation region correction step that corrects, when the lane change detection step detects the lane change of the own vehicle, the operation region based on lane information related to a traffic lane after the lane change of the own vehicle; and
an operation determination step that determines, when an object is detected in the operation region, whether a driving assist operation needs to be activated based on the periphery monitoring information.
